(19) United States
(12) Patent Application Publication
(10) Pub. No.: US 2017/0320090 A1
(43) Pub. Date: Nov. 9, 2017

(54) Integrated unit for treatment and drying lignocellulosic material

(71) Applicant: Jacques Roy, Quebec (CA)

(72) Inventor: Jacques Roy, Quebec (CA)

(21) Appl. No.: 15/145,949

(22) Filed: May 4, 2016

(51) Int. Cl. B05D 3/00; F26B 23/06; F26B 23/02; F26B 3/04; F26B 25/06; F26B 9/06

(52) U.S. Cl. CPC B05D 3/007; F26B 25/063; F26B 9/06; F26B 23/028; F26B 3/04; F26B 23/06; F26B 2200/02; F26B 2200/24; F26B 2210/16

(57) ABSTRACT

An integrated boiler-dryer consisting in a sealable vessel capable of sustaining high humidity and variable gas pressures and into which is placed a lignocellulosic material, and a compound in mist form. The sealable vessel provides dry heat so as to dry the lignocellulosic material while the compound is impregnated within the lignocellulosic material.

### FIELD OF THE INVENTION

The present invention relates generally to lignocellulosic material processing but more particularly to an integrated unit for treatment and drying lignocellulosic material.

### BACKGROUND OF THE INVENTION

Wood or wood products are dried in ovens (kiln or dryers) regardless of the treatment that is done in other production units (usually pressurized cylinders). This production requires a lot of handling between the different equipment used. It can even happen that the wood has to return to the dryer after treatment. Which creates additional costs and time. Currently, there is a wide variety of dryer shapes and sizes as well as a variety of equipment for ventilation, heating, control, etc, that are used in the wood industry, but none allow for the chemical treatment of wood products in a single unit.

Applicant did file patent, U.S. Pat. No. 7,246,452, describing a method for heat treating preservative-treated wood, as well as U.S. Pat. No. 7,754,284, describing a method for treating lignollulosic material, both patents being incorporated herein by reference. In the U.S. Pat. No. 7,754,284 patent, Applicant did mention: “In a further embodiment, it will be appreciated that the wood may be treated during the drying process. For example, the preservative may be incorporated in the water vapor utilized to heat the wood. The heating process may also be coupled with known processes for incorporating preservatives in wood”. However, this statement was rather theoretical and it was not so obvious to actually create an integrated unit for drying and treating lignocellulosic material.

### SUMMARY OF THE INVENTION

In view of the foregoing disadvantages inherent in the known devices now present in the prior art, the present invention, which will be described subsequently in greater detail, is to provide objects and advantages which are:

To provide for a practical integrated unit for treatment and drying of lignocellulosic material in a single step inside a single production equipment.

Another advantage is to make it so that the material can be dried to a desired moisture content and be treated without having to move the material, drying can even be continued if necessary in the same integrated unit.

Another advantage is that the integrated unit allows the use of different compounds at different concentrations and/or a combination of compounds.

Yet another advantage of combining treatment in drying in an integrated unit is to greatly reduce the costs associated these two operations versus when they are done separately (reduced energy, handling, transportation, logistics, labor, etc).

Still another advantage of the integrated unit is to provide a sealed vessel (chamber) capable of sustaining high humidity and variable gas pressures and into which is placed a lignocellulosic material, and a compound in mist form. The vessel or chamber provides dry heat so as to dry the lignocellulosic material while the compound is impregnated within the lignocellulosic material.

Yet another advantage of the integrated unit is that the compounds used can be of the types that are dissolved in water, or other diluents, alcohol or monomers or polymers.

Still another advantage of the integrated unit is that it can used granular ingredients such as salt which are then admixed to form a solution.

In order to do so, the integrated unit for the treatment and the drying of lignocellulosic material is comprised of a chamber having walls on three sides, and a doorway on a fourth side, a ceiling, and a floor that slopes towards a collecting basin section to collect a substance and a leachate.

At least two of the walls have track members onto which are installed a plurality of spraying nozzles. At least one vent opening to vent off excess humidity within the chamber. At least one fan, and at least one heating element within the chamber. A rolling carriage configured to carry a load of lignocellulosic material, and sized to fit inside the chamber.

The nozzles are spraying a liquid mist coming from external pipes and wherein the liquid mist consisting in the substance designed for treating the lignocellulosic material.

The heating element is an electrical heating element or a coil inside which flows a hot fluid.

The hot fluid is heated electrically or by way of a flame.

Alternatively, the heating element can be an open flame which is generated from a carbon based source or a bio-mass source.

The at least one fan and the at least one heating element are located inside a container, wherein the container is located above deflectors which are located above the carriage.

Hoppers provide ingredients that are admixed in a mixing tank so as to create the substance which is then being pumped by way of a main pump into pipes.

The floor of the chamber has rails onto which rolls the carriage and is sloped towards a collecting basin section which collects the substance and leachate from the ligno cellulosic material as it is being treated.

A secondary pump pumps the substance and the leachate through a filter to separate the leachate from the substance and delivers the recuperated substance into a secondary mixing tank.

Then, the main pump pumps from both the main mixing tank and the secondary mixing tank and delivers the substance through the pipes.

Ideally, the substance is heated before being pumped into the chamber.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiment and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiment of the invention.

### BRIEF DESCRIPTION OF THE DRAWINGS

FIG. 1 Isometric view of the invention.

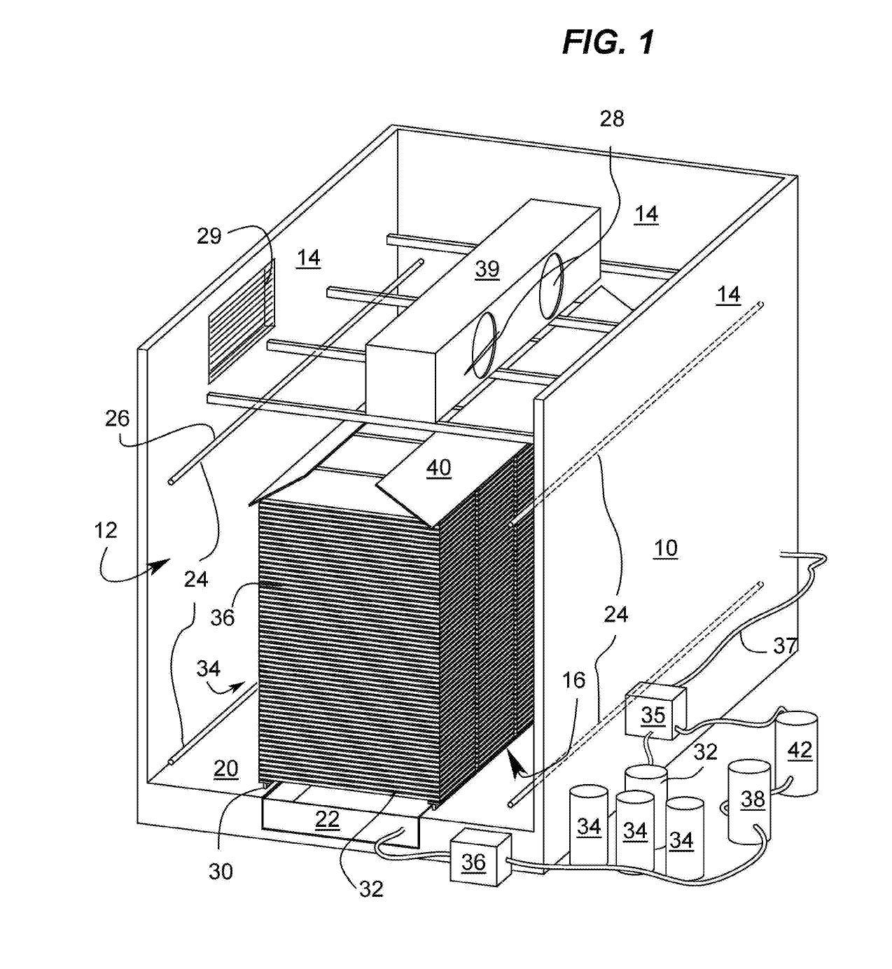

FIG. 2 Front view of the invention.

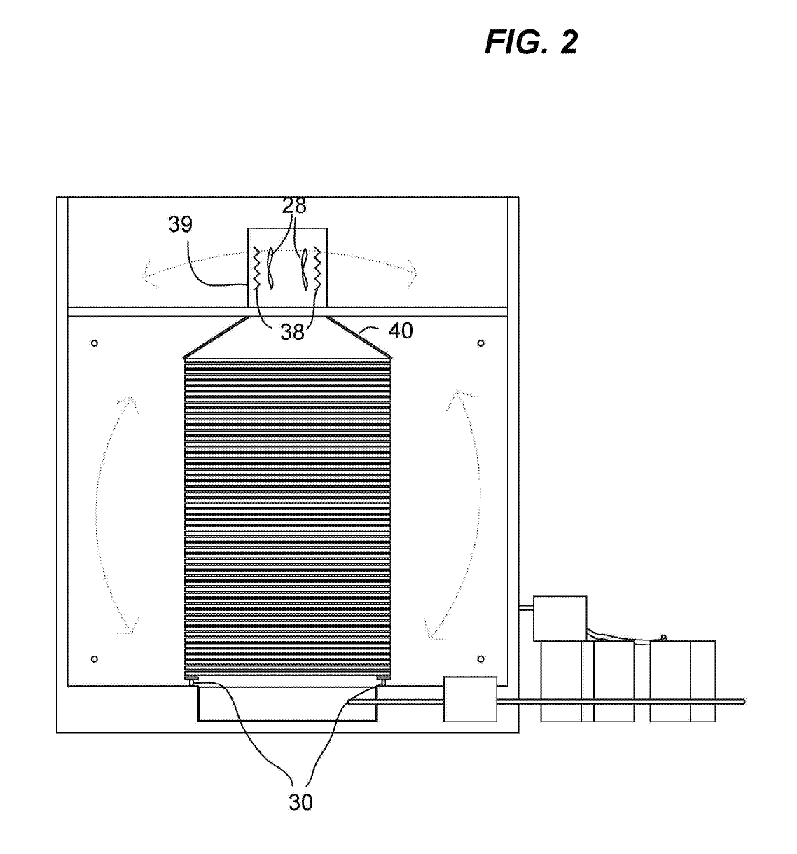

### DETAILED DESCRIPTION

The invention allows for combining the teachings of Applicant's own previous patent, U.S. Pat. No. 7,246,452, describing a method for heat treating preservative-treated wood, along with the teachings of Applicant's other patent, namely U.S. Pat. No. 7,754,284, describing a method for treating lignocellulosic material, both patents being incorporated herein by reference.

An integrated unit (10) is comprised of a chamber (12) having three walls (14), a doorway (16), a ceiling (18), and a floor (20) that slopes towards a collecting basin (22). At least two walls (14) have tracks (24) onto which are installed a plurality of spraying nozzles (26). There is also at least one vent (29) to vent off excess humidity.

The floor (20) has rails (30) onto which rolls a carriage (32) supporting a racking system (34), which is generally nothing more than slats separating rows of lignocellulosic material (36) to be processed.

The chamber (12) also has fans (28), and heating elements (38) located inside a container (39) and over deflectors (40). The heat comes either from electricity or from a hot fluid circulating inside coils. Alternatively, heat can be produced by direct flames from carbon based sources or bio mass. The heat for the fluid can come from electricity from carbon based sources, or bio mass.

The nozzles (26) are spraying a mist of fine liquid droplets that can travel in between rows and into the material (36). The mist consist in one of several possible substances which are admixed outside of the chamber (12), in a main mixing tank (32) which takes its ingredients from hoppers (34). From the hoppers (34) if the ingredients are granular, they may be fed by gravity, if in liquid, either by gravity or by pump to the mixing tank. From the main mixing tank (32), the ingredients are pumped by a main pump (35) and directed towards the nozzles (26) by way of pipes (37).

The base ingredients can be granular salts mixed with water but several other ingredients can be used for the treatment. While the various substances are admixed, they are also heated so as to increase the dilution characteristics as well as not to cause a cooling effect upon entering the chamber (12).

Because the mist is sprayed equally inside of the chamber (12), as much as 80% of it may not reach the intended target and as such, condenses and rains down to the floor (20) and then to the collecting basin (22). From there, a second pump (36) pumps it through a filter (38) to remove contaminants gathered during the process, then a secondary mixing tank (42), and then back through the main pump (35).

By combining the method of treatment in the same unit as the drying process, the material (36) can be dried to a desired moisture content and be treated without having to move the material (36). Drying can even be continued long after the treatment with the compound is completed, if necessary. Furthermore, the unit (10) allows the use of different compounds at different concentrations and/or a combination of compounds.

The unit (10) greatly reduces the costs associated with the combination of these two stages of production (energy, handling, transportation, logistics, labor).

This unit (10) also has the advantage of recovering the water and the compounds used (residuals). The other advantage is the recycling of the residuals. This recycling is not made in current dryers, but is mandatory in processing units for the protection of the environment.

The unit (10) can be fixed or mobile. It only requires connection (electricity, water and heat energy) to be operational.

With respect to the above description, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1) An integrated unit for the treatment and the drying of lignocellulosic material is comprised of a chamber having walls on three sides, and a doorway on a fourth side, a ceiling, and a floor that slopes towards a collecting basin section to collect a substance and a leachate; at least two of said walls have track members onto which are installed a plurality of spraying nozzles; at least one vent opening to vent off excess humidity within said chamber; at least one fan, and at least one heating element within said chamber; a rolling carriage configured to carry a load of lignocellulosic material and sized to fit inside said chamber; said nozzles spraying a liquid mist coming from external pipes and wherein said liquid mist consisting in said substance designed for treating said lignocellulosic material.

2) The integrated unit of claim 1 wherein said heating element being an electrical heating element.

3) The integrated unit of claim 2 wherein said heating element being a coil inside which flows a hot fluid.

4) The integrated unit of claim 3 wherein said hot fluid is heated electrically.

5) The integrated unit of claim 3 wherein said hot fluid is heated by way of a flame.

6) The integrated unit of claim 1 wherein said heating element is an open flame.

7) The integrated unit of claim 5 wherein said flame is from a carbon based source.

8) The integrated unit of claim 6 wherein said open flame is from a carbon based source.

9) The integrated unit of claim 6 wherein said open flame is from a bio-mass source.

10) The integrated unit of claim 1 wherein said at least one fan and said at least one heating element are located inside a container.

11) The integrated unit of claim 10 wherein said container is located above deflectors which are located above said carriage.

12) The integrated unit of claim 1 wherein hoppers provide ingredients that are admixed in a mixing tank so as to create said substance, and said substance being pumped by way of a main pump into pipes.

13) The integrated unit of claim 1 wherein said floor has rails onto which rolls said carriage.

14) The integrated unit of claim 1 wherein said collecting basin section collects said substance and leachate from said ligno cellulosic material.

15) The integrated unit of claim 1 wherein a secondary pump pumps said substance and said leachate through a filter to separate said leachate from said substance and delivers said recuperated substance into a secondary mixing tank.

16) The integrated unit of claim 1 wherein said main pump pumps from both said main mixing tank and said secondary mixing tank and delivers said substance through said pipes.

17) The integrated unit of claim 1 wherein said substance is heated before being pumped into said chamber.

18) The integrated unit of claim 1 wherein compounds used can be dissolved in diluents including, but not limited to water, alcohol, monomers, polymers.
